(19) United States
(12) Patent Application Publication
(10) Pub. No.: US 2015/0375406 A1
(43) Pub. Date: Dec. 31, 2015

(54) IMPROVED SCISSORS FOR HAIRDRESSER

(71) Applicant: Alessandro DE STEFANO, (US)

(72) Inventor: Alessandro DE STEFANO, Pozzilli (IT)

(21) Appl. No.: 14/768,796

(22) PCT Filed: Feb. 26, 2014
(86) PCT No.: PCT/IT2014/000055

§ 371 Date: Aug. 19, 2015

(30) Foreign Application Priority Data
Mar. 1, 2013 (IT) RM2013U000041

(51) Int. Cl. B26B 13/20

(52) U.S. Cl. CPC B26B 13/20

(57) ABSTRACT

The present invention relates to scissors which are to be used by hairdressers, barbers and groomers. The scissors rings 8, 9, into which the fingers of the hand are inserted, can be rotated 360° about a pin fixed to the supports 6, 7 integral with the blades. One ring has the pin 11 arranged parallel to the longitudinal axis of the scissors; and the other ring has the pin 10 arranged perpendicular to the longitudinal axis of the scissors.

### STATE OF THE ART

Scissors, as everyone knows, are a manual cutting tool consisting of two crossed blades which can open and close by rotating about a fixed central pin, the blades are provided at the end thereof with two rings in which to insert the fingers, which allow to operate the blades.

Scissors are used in many activities and each activity has specially designed scissors in order to achieve the best result.

For example, in the field of tailoring, it is common to use very long scissors to cut fabric; in the field of manicure and pedicure, there exist curved or very small scissors and so forth.

In the field of hairdressers, barbers and groomers, it is common to use scissors with blades of various shapes; in some models, one of the blade-commanding rings is completed by an external lever for more easily moving a blade using, for example, the little finger as well.

Scissors for hair stylists, hairdressers and barbers ease the operator's task, however they do not permit to be used with all inclinations and directions since the position of the rings conditions the position of the hand.

The difficulty of angling the hand in function of the needs of the cut compels the hairdresser to assume incorrect postures with the back, the trunk, the arms and consequently also with the neck. Such incorrect postures, besides being extremely harmful to the backbone and the musculature, increase fatigue and tiredness due to the work which, as is known, is totally carried out standing up.

In order to obviate the drawbacks briefly described above, it is necessary that the scissors, and in particular the blade, can assume during the cut, a different inclination, with respect to the natural position of the hand.

There are commercially available scissors in which the ring into which the thumb is inserted can be rotated, but the rotation of a single ring does not allow to solve the problems described above.

### DESCRIPTION OF THE INVENTION

The object of the present invention are improvements to scissors which permit to rotate 360° the position of both rings into which fingers are inserted.

According to the present invention, the two rings which permit to move the blades can rotate 360° about different axes of rotation; a ring can rotate 360° about a vertical pin, while the other ring can rotate 360° with respect to a horizontal pin.

This feature allows, for example, the ring rotating about the vertical pin to be orientated with an angulation of the hole with respect to the blades which is functional to the insertion of the hand's finger which results to be more comfortable and in a natural position for the cut which is to be performed; the other ring can be positioned either in the same position as the first ring, or in a position rotated with respect to the first ring, thanks to the horizontally arranged pin. This permits the ring rotating about the horizontal pin to assume all the positions comprised between the usual upper position and the overturned position facing towards the blade tip.

The possibility to rotate a ring and to rotate, angulate and overturn the other ring permits to use the hand's fingers which usually are not used to operate scissors; it is possible for example to use the ring finger and the thumb, operating with the scissors blades facing either upwards or downwards indifferently.

The invention will now be described in an embodiment, given by way of example and without limitation, with reference to the enclosed figures, wherein:

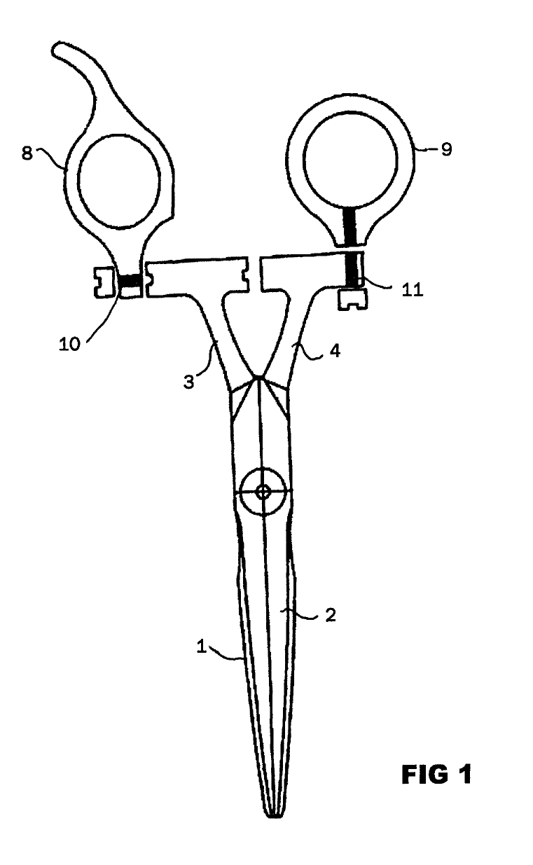

FIG. 1 shows a plan view of the scissors

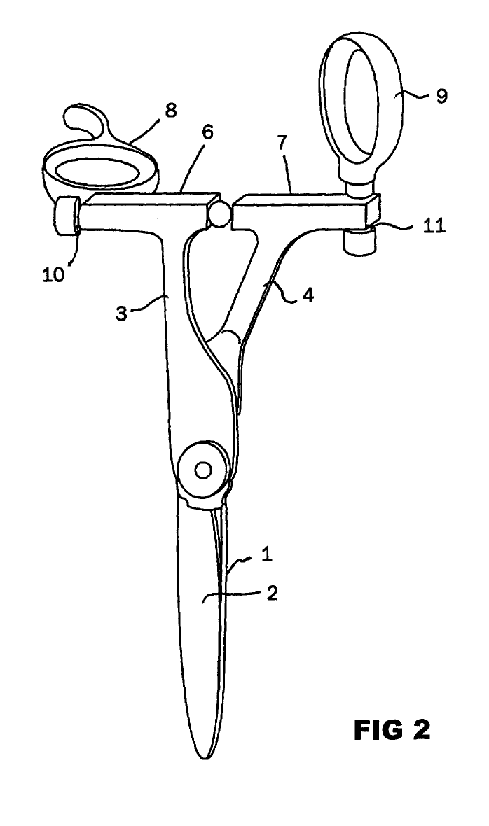

FIG. 2 shows a view of the scissors having the rings in one of the possible positions

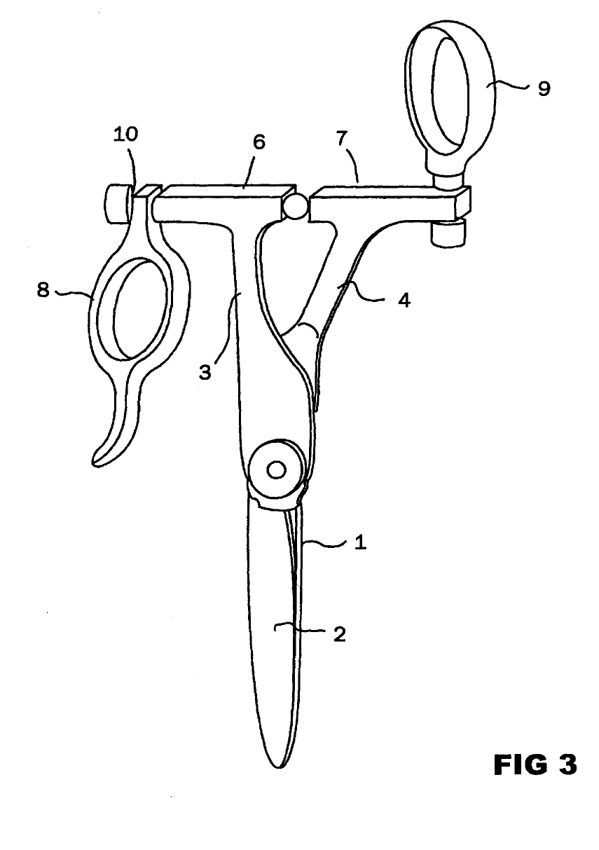

FIG. 3 shows the scissors having the rings in another of the possible positions

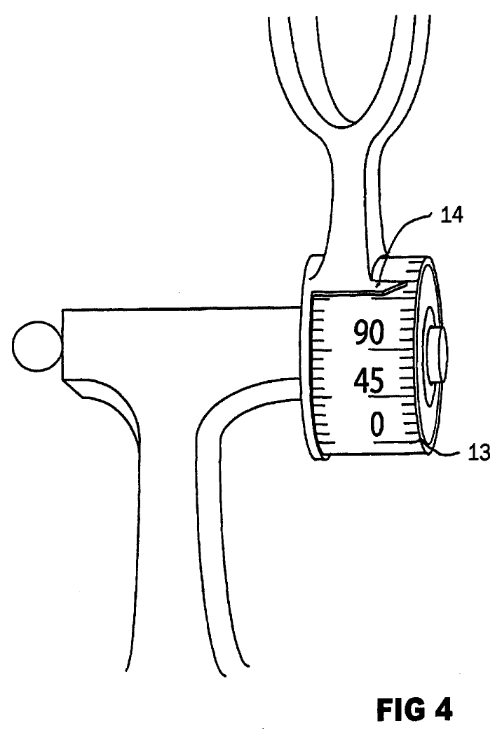

FIG. 4 shows the base of the rings of the scissors provided with a circle with graduated scale.

With reference to said figures, the scissors of the present invention result to be composed of two blades (1) and (2) which rotate about a fixed pin. Each blade is integral, in the portion opposite to the tip, with an arm (3) and (4); each arm (3) and (4) is integral with a support (6) and (7) orthogonal to the longitudinal axis of the scissors; pivotally constrained to the outer end of each of the supports (6) and (7) is a ring (8) and (9) into which the finger for commanding the corresponding blade is inserted.

The pin (10) which pivotally constrains the ring (8) to the support (6), is situated in correspondence of the longitudinal axis of the support (6), so as to enable the ring (8) to make a 360° rotation parallel to the longitudinal axis of the scissors; the pin (11) which pivotally constrains the ring (9) to the support (7) is positioned perpendicular to the longitudinal axis of the support (7), so as to enable the ring (9) to make a 360° rotation orthogonal to the longitudinal axis of the support (7).

In practice, the ring (8) can be rotated 360° about the pin (10) and arranged in the most convenient position: the ring (8) can be arranged and stopped in the usual position for scissors, in the diametrically opposite position, i.e. facing towards the scissors tip, and in any intermediate position therebetween.

Similarly, the ring (9) can be arranged in the usual position for scissors, or rotated 360° about the axis of the pin (11) and blocked in any position which is deemed to be convenient.

Rings (8) and (9), at the holes for the passage of the threaded pins (10 and 11), are provided with bushings which perform a “clutch” effect by slowing down the rotation and allowing the ring to be positioned in the exact desired position before it is blocked by tightening the threaded pin (10-11).

The bushings can be made of any suitable material such as rubber, Teflon or other suitable materials.

The rotation of the rings (8) and (9) permits, as mentioned above, to use the scissors no longer only with the thumb and middle finger, as it usually happens with traditional scissors, but also with the other fingers coupled in the way deemed most convenient.

Always thanks to the possibility of rotation and angulation of the rings (8) and (9) it is possible to operate the blades in any direction keeping the hand always in a proper and not tiring position.

For example, it is possible, keeping the hand in a natural position, to operate the scissors with the blade tip facing the back of the hand; or with the blades facing upwards and making them pass between the index finger and the middle finger and so forth.

The ring (8) by means of which the blade (2) is operated may be provided with a lever (12) which permits to move the blade using the little finger of the hand.

The possibility of orienting the rings (8) and (9) allows the scissors to be easily used by left-handed persons as well.

In order to confer to the scissors of the present invention the possibility to be used for a long time without causing tiredness in the hand, the arms (3 and/or 4) may be appropriately shaped so as to offer a support to the fingers which are not engaged in the rings (8) and (9).

The blades (1) and (2) may be made of either rigid steel or flexible metal.

It is further provided that in the attachment point of the rings (8 and 9) with the supports (6 and 7) a graduated circle (13) is interposed; an index (14) integral with each of the rings (8 and 9) indicates on the corresponding graduated circle the position/s of the ring and allows to find it/them again, after the ring has been rotated to perform a different cut or because the scissors have been used by another person.

1-7. (canceled)

8. Scissors for hairdressing comprising a first blade; a second blade; a first arm integral with the second blade; a second arm integral with the first blade; a pin about which the first blade and the second blade rotate; a first ring and a second ring each sized to receive a finger to operate the first blade and the second blade, wherein one of said first ring and said second ring is orientable;
a first support orthogonal to a longitudinal axis of the scissors and integral with the first arm which in turn is integral with the second blade;
a second support orthogonal to the longitudinal axis of the scissors and integral with the second arm which in turn is integral with the first blade;
a first pin pivotally constrained to an end of the first support;
a second pin pivotally constrained to an end of the second support;
wherein the first pin is pivotally constrained to the end of the first support by a first retaining component located in correspondence to the longitudinal axis of the first support and is rotatable 360° about an axis of the first retaining component and is blockable in a selected position; and
wherein the second pin is pivotally constrained to an end of the second support by a second retaining component orthogonal to a longitudinal axis of the second support and is rotatable 360° about an axis of the second retaining component and is blockable in a selected position.

9. The scissors according to claim 8, wherein the first pin is a threaded pin.

10. The scissors according to claim 8, wherein the second pin is a threaded pin.

11. The scissors according to claim 9, wherein interposed between the first pin and the first ring is a bushing which functions as a clutch so as to position the first ring in the selected position.

12. The scissors according to claim 10, wherein interposed between the second pin and the second ring is a bushing which functions as a clutch so as to position the second ring in the selected position.

13. The scissors according to claim 8, wherein the first ring includes a lever to control the second blade with a finger.

14. The scissors according to claim 8, wherein the first blade and the second blade are made of a flexible material.

15. The scissors according to claim 8, wherein a point of attachment of each of the first pin and the second pin with the first support and the second support, respectively, is a graduated circle and an index integral with each of the first ring and the second ring which indicates a position of the first ring and the second ring with respect to the graduated circle.
